(19) United States
(12) Patent Application Publication
(10) Pub. No.: US 2026/0179263 A1
(43) Pub. Date: Jun. 25, 2026

(54) IMAGE DECODER WITH TEXT TOKEN CONDITIONING

(71) Applicant: Lemon Inc., Grand Cayman (KY)

(72) Inventors: Dongwon Kim, Los Angeles, CA (US); Ju He, Los Angeles, CA (US); Qihang Yu, Los Angeles, CA (US); Chenglin Yang, Los Angeles, CA (US); Xiaohui Shen, Los Angeles, CA (US); Liang-Chieh Chen, Los Angeles, CA (US)

(21) Appl. No.: 19/057,407

(22) Filed: Feb. 19, 2025

Related U.S. Application Data
(60) Provisional application No. 63/737,175, filed on Dec. 20, 2024.

(51) Int. Cl. G06T 11/00; G06F 40/126

(52) U.S. Cl. CPC G06T 11/00; G06F 40/126

(57) ABSTRACT

A computing system including one or more processing devices configured to receive a text prompt. At a text encoder, the one or more processing devices are further configured to compute one or more text tokens based at least in part on the text prompt. At a text-to-image (T2I) generative model, the one or more processing devices are further configured to compute a plurality of latent image tokens based at least in part on the one or more text tokens. At an image decoder, the one or more processing devices are further configured to receive the latent image tokens and the one or more text tokens. The one or more processing devices are further configured to compute an output image based at least in part on the latent image tokens and the one or more text tokens. The one or more processing devices are further configured to output the output image.

### CROSS REFERENCE TO RELATED APPLICATIONS

This application claims priority to U.S. Provisional Patent Application Ser. No. 63/737,175, filed Dec. 20, 2024, the entirety of which is hereby incorporated herein by reference for all purposes.

### BACKGROUND

In recent years, text-to-image (T2I) generation has seen remarkable progress across various frameworks, including diffusion models, autoregressive visual models, and masked generative models. One component of these models is an image tokenizer-either discrete or continuous-which transforms images into tokenized representations. These T2I models then incorporate text conditions with the tokenized representations using methods such as cross-attention, concatenation, or conditioning embeddings, ultimately leveraging the tokenizer to generate images aligned with input text prompts.

### SUMMARY

According to one aspect of the present disclosure, a computing system is provided, including one or more processing devices configured to receive a text prompt. At a text encoder, the one or more processing devices are further configured to compute one or more text tokens based at least in part on the text prompt. At a text-to-image (T2I) generative model, the one or more processing devices are further configured to compute a plurality of latent image tokens based at least in part on the one or more text tokens. At an image decoder, the one or more processing devices are further configured to receive the latent image tokens and the one or more text tokens. The one or more processing devices are further configured to compute an output image based at least in part on the latent image tokens and the one or more text tokens. The one or more processing devices are further configured to output the output image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which one or more processing devices are configured to train an image tokenizer, according to one example embodiment.

FIG. 2A schematically shows the computing system when an output vector of training latent image tokens is computed from a training text input during training of a text-to-image (T2I) generative model, according to the example of FIG. 1.

FIG. 2B schematically shows the further processing of the output vector in a continuous token configuration during training of the T2I generative model, according to the example of FIG. 2A.

FIG. 2C schematically shows the further processing of the output vector in a discrete token configuration during training of the T2I generative model, according to the example of FIG. 2A.

FIG. 3A schematically shows the computing system when an output vector of latent image tokens is computed from a text prompt at the T2I generative model during inferencing time, according to the example of FIG. 2A.

FIG. 3B schematically shows the computing system when the output vector is further processed at inferencing time to computing an output image, according to the example of FIG. 3A.

FIG. 4A shows a flowchart of a method for use with a computing system to compute an output image from a text prompt at a T2I generative model, according to the example of FIG. 1.

FIGS. 4B-4G show additional steps of the method of FIG. 4A that may be performed in some examples.

FIG. 5 shows a schematic view of an example computing environment in which the computing system of FIG. 1 may be instantiated.

### DETAILED DESCRIPTION

Previous image tokenizers typically rely on two-dimensional (2D) grid-based latent representations. These 2D latent representations often struggle to handle redundancies in images, in which neighboring patches of the images display similarities. Another previous approach utilizes a transformer-based one-dimensional (1D) tokenizer, which efficiently tokenizes images into compact 1D latent sequences by removing the fixed correspondence between latent representations and 2D image patches. Thus, each 1D token can represent any region in an image, rather than being tied to a specific patch. This 1D tokenizer has a significantly higher sampling speed than previous methods.

However, extending the transformer-based 1D tokenizer to support T2I generation presents three main challenges: (1) its reliance on a complex two-stage training pipeline, which limits scalability to larger datasets necessary for diverse text-to-image generation; (2) its restriction to a Vector-Quantized (VQ) variant, leaving unexplored the potential benefits of a continuous Variational Autoencoder (VAE) representation; and (3) its focus on reconstructing low-level image details, which may lack the high-level semantics needed for effective alignment with textual descriptions.

To address these shortcomings, the present disclosure introduces the following features. First, the approaches discussed herein streamline the training process for the 1D tokenizer by developing an efficient one-stage training procedure, removing the need for the complex two-stage pipeline used in the original framework. This feature enables scalable training of the 1D tokenizer on large-scale text-image datasets without multi-stage complexity.

Second, the techniques discussed herein extend the 1D tokens to continuous VAE representations, which allow for more consistent and accurate image reconstructions than the VQ counterpart. This technique combines the sampling efficiency of 1D tokens (due to the reduced number of tokens) with the high reconstruction quality afforded by the continuous VAE representations, eliminating the quantization loss seen in the VQ variant.

Third, the approach discussed herein incorporates textual information during the detokenization stage to enhance semantic alignment with text prompts. Specifically, by concatenating text embeddings of captions with the tokenized image representations, these techniques enable higher-quality image reconstructions that more accurately retain fine details.

Building on the text-aware transformer-based 1D tokenizer, a masked T2I generative model is also presented herein. This masked T2I generative model supports both discrete and continuous token representations. For images represented by discrete tokens, the masked T2I generative model is trained using cross-entropy loss, while for images with continuous tokens, it leverages diffusion loss. In terms of architecture, the masked T2I generative model adopts a structure that concatenates text conditions with image tokens before feeding the concatenated inputs to a transformer network. The masked T2I generative model utilizes separate adaptive LayerNorm (adaLN) parameters for text and image modalities.

Masked generative models make use of mask scheduling when computing their outputs. The masked T2I generative model incorporates a masking rate as an additional conditioning signal via adaLN. Incorporating the masking rate as a conditioning signal allows for more nuanced control over the generated images, beyond text input alone.

The masked T2I generative model was trained on images from publicly available sources, as well as on synthetic data. Given the noisiness of web-sourced text-image pairs, the training dataset was filtered based on aesthetic scores (≥5), resolution (aspect ratio<2 and longer side≥256). Images containing watermarks were also removed. Text quality was also enhanced by recaptioning high-aesthetic-score subsets of the training dataset.

Notably, despite being trained entirely on publicly available datasets, the masked T2I generative model achieves strong performance and efficiency in text-to-image generation. On the MJHQ-30K benchmark, a 568M-parameter masked T2I generative model with discrete tokens achieves a generation FID of 8.75, which outputs an existing state-of-the-art T2I generative model (scoring 14.99) with 30.9× faster inference throughput. The masked T2I generative model also outperforms two other recent T2I generative models (scoring 26.96 and 9.85, respectively) while requiring only 2% and 21% of their respective training times. Furthermore, a 1.1B-parameter version of the masked T2I generative model achieves FID scores of 8.46 and 7.81 on MJHQ-30K and overall scores of 0.56 and 0.53 on the GenEval benchmark using discrete and continuous tokens, respectively.

Previous techniques related to image tokenization and T2I generation are discussed below. Recent generative image models rely on image tokenization for efficient generation. During training, images are encoded into discrete or continuous tokens, allowing the model to focus on learning semantically meaningful information rather than directly working with pixels.

Image tokenization approaches fall into two main paradigms. The first, discrete tokenization, maps each token to a codebook entry and is well-suited to autoregressive or masked generative models, as it enables techniques to be adopted directly from language models. This approach has been further scaled through advanced codebook management techniques.

The second paradigm, continuous tokenization, follows the variational autoencoder (VAE) framework, enabling latent representations drawn from a normal distribution. While less common with masked generative models due to the simpler loss definitions with discrete tokens, continuous tokenization can be used with diffusion models to sample tokens from the normal distribution.

Initially developed for language tasks, sequence models have been effectively adapted for image generation. Early approaches focused on autoregressive pixel generation, but recent methods model the joint distribution of image tokens, leading to two main approaches: autoregressive and masked generative models.

Autoregressive models predict tokens sequentially, while masked generative models predict masked tokens simultaneously. Masked models accordingly have a substantial edge in sampling speed, as they do not require token-by-token generation. Building on these efficiency benefits, the masked T2I generative model presented herein leverages 1D tokenization for efficient text-to-image generation.

While diffusion models dominate text-to-image generation, sequence models have shown strong potential as well. Masked generative and autoregressive approaches have been used to generate high-quality images from text. Recent techniques used with diffusion models, such as architectural changes, micro-conditioning for finer control, and image recaptioning for better text-image alignment, also offer potential benefits for masked generative models. The masked T2I generative model discussed herein adapts these techniques from the diffusion model framework into the masked generative model framework. Thus, the masked T2I generative model has higher generated image quality while maintaining the sampling efficiency advantage of masked generative models.

A previous transformer-based 1D vector-quantized (VQ) tokenizer is discussed below. This image tokenizer diverges from traditional 2D grid-based latent space tokenization, instead opting for a compact 1D representation that bypasses 2D spatial structure preservation. Given an input image I∈ [symbol] ^{H×W×3}, the tokenization phase of the transformer-based 1D tokenizer involves downscaling the image by a factor of f, resulting in patches

$$P ∈ {ℝ}^{\frac{H}{f} \times \frac{W}{f} \times D} .$$

These patches are concatenated with a set of latent tokens L∈ [symbol] ^{K×D}. The combined sequence is then passed through a Vision Transformer (ViT) encoder, Enc, to generate embeddings. Only the embeddings corresponding to the latent tokens, Z_{1D}∈ [symbol] ^{K×D}, are retained, forming a compact 1D latent representation. This representation is then quantized using a quantizer Quant by mapping it to the nearest codes in a learnable codebook.

In the detokenization phase, the previous transformer-based 1D tokenizer uses a sequence of mask tokens

$$M ∈ {ℝ}^{\frac{H}{f} \times \frac{W}{f} \times D} ,$$

which are concatenated with the quantized codes. The resulting sequence is processed by a ViT decoder, Dec, to reconstruct the image Î. Formally, with ⊕ denoting concatenation, the tokenization and detokenization processes can be represented as:

$${Z}_{1 D} = E n c ( P ⊕ L )$$

$$\hat{I} = Dec ( Quant ( {Z}_{1 D} ) ⊕ M )$$

Continuous and discrete tokens in existing masked generative models are discussed below. Masked generative models with discrete tokens adapt the masked language modeling framework for image generation. During training, a portion of the set of image tokens is masked, and a bidirectional transformer predicts these tokens using the surrounding context. The model employs a classification head to select tokens from a predefined codebook and uses cross-entropy loss for training.

During sampling, the model iteratively predicts tokens for masked positions, retaining high-confidence tokens while re-masking uncertain ones until all positions are filled. The completed sequence of tokens is then de-tokenized into pixel space to form the final image.

Masked generative models with continuous tokens maintain a conceptual similarity to discrete-token models but operate on continuous tokens, which reduces information loss from quantization. Diffusion loss may be used, which enables these models to approximate the distribution of each image token independently. In this framework, transformer layers generate a conditioning vector for each masked token, which is then input into a small multi-layer perceptron (MLP) that learns a denoising function conditioned on the conditioning vector. This per-token conditioning and denoising allow the sampling process to directly apply to the probability distribution of each token.

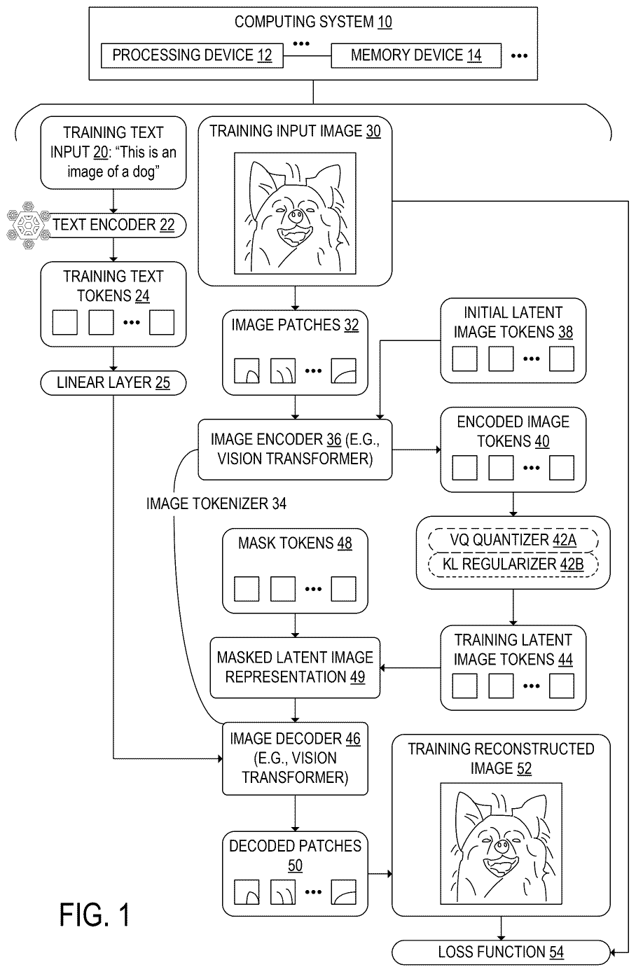

The text-aware transformer-based 1D tokenizer is discussed in further detail below. FIG. 1 schematically shows a computing system 10 during a training stage in which an image tokenizer 34 is trained. The computing system 10 includes one or more processing devices 12 and one or more memory devices 14. For example, the one or more processing devices 12 may include one or more central processing units (CPUs), graphics processing units (GPUs), and/or neural processing units (NPUs). The one or more memory devices 14 may include volatile memory and/or non-volatile storage.

In contrast to the previous transformer-based 1D tokenizer, which relies on two-stage training, the image tokenizer 34 shown in FIG. 1 has a one-stage training approach. This approach allows the image tokenizer 34 to be trained more efficiently than the previous transformer-based 1D tokenizer. The image tokenizer 34 also supports both discrete and continuous tokens and incorporates textual information during detokenization to enhance semantic alignment.

As shown in the example of FIG. 1, the one or more processing devices 12 are configured to receive a plurality of training input images 30. In addition, the one or more processing devices 12 are configured to receive a plurality of training text inputs 20 respectively associated with the training input images 30. The training pipeline of the image tokenizer 34 is shown in FIG. 1 for an example training input image 30 depicting a dog, which is paired with the training text input “This is an image of a dog.”

The one or more processing devices 12 are further configured divide the training input image 30 into a plurality of image patches 32. The image patches 32 each have a predetermined size.

The image tokenizer 34 shown in the example of FIG. 1 includes an image encoder 36 and an image decoder 46. The image encoder 36 may, for example, have a vision transformer (ViT) architecture. For each of the training input images 30, the one or more processing devices 12 are further configured to compute a plurality of encoded image tokens 40 at the image encoder 36 based at least in part on the training input image 30. The image encoder 36 may compute a respective encoded image token 40 for each image patch 32. In addition, the image encoder 36 is configured to receive a plurality of initial latent image tokens 38 as input. The initial latent image tokens 38 encode a latent representation vocabulary of the image encoder 36 and are learnable tokens that are randomly initialized. The encoded image tokens 40 computed at the image encoder 36 are arranged in a 1D token vector Z_{1D}.

The one or more processing devices 12 are further configured to quantize or regularize the encoded image tokens 40. This quantization or regularization may be performed at a VQ quantizer 42A or a Kullback-Leibler (KL) regularizer 42B. Accordingly, the one or more processing devices 12 are configured to compute a plurality of training latent image tokens 44 based at least in part on the encoded image tokens 40. The VQ quantizer 42A is used in the discrete tokenizer configuration, whereas the KL regularizer 42B is used in the continuous tokenizer configuration.

In the continuous tokenizer configuration, the one or more processing devices 12 are configured to represent Z_{1D} as a Gaussian distribution. The one or more processing devices 12 are further configured to apply KL divergence regularization to the encoded image tokens 40 at the KL regularizer 42B, resulting in a compact 1D VAE representation. This continuous representation retains the efficiency and structure of the previous transformer-based 1D tokenizer, while also consistently improving reconstruction quality by avoiding the information loss associated with quantization. In addition, the continuous tokenizer may be integrated seamlessly with diffusion models, serving as a drop-in replacement for standard 2D VAEs. This modification achieves a significant reduction in training costs and an increase in inference speed, all while maintaining comparable performance. Continuous tokenization therefore contributes to both the efficiency and flexibility of diffusion-based generation.

In both the discrete and continuous configurations, the one or more processing devices 12 are further configured to mask a subset of the training latent image tokens 44 using respective mask tokens 48 to obtain a masked latent image representation 49. The proportion of the training latent image tokens 44 that are masked may be randomly selected for each of the training input images 30. In addition, the specific latent image tokens 44 that are masked may also be randomly selected.

The one or more processing devices 12 are further configured to process the training text input 20 at a text encoder 22. The text encoder 22 is a pretrained text encoder and has frozen weights during the training of the image tokenizer 34. At the text encoder 22, the one or more processing devices 12 are configured to compute one or more training text tokens 24 based at least in part on the training text input 20 associated with the training input image 30. The one or more processing devices 12 may be further configured to project the one or more training text tokens 24 a linear layer 25 to align with the channel dimensions of the image decoder 46. The resulting projected training text tokens are indicated below as T∈ [symbol] _{N×D}, where N is a predefined number of context tokens.

At the image decoder 46 included in the image tokenizer 34, the one or more processing devices 12 are further configured to compute a training reconstructed image 52 based at least in part on the masked latent image representation 49 and the one or more training text tokens 24. The projected training text tokens T are concatenated with the latent tokens Z_{1D} and the mask tokens M to form the input of the image decoder 46. Similarly to the image encoder 36, the image decoder 46 may have a ViT architecture. In the example of FIG. 1, the one or more processing devices 12 are configured to compute a plurality of decoded patches 50 at the image decoder 46 and are further configured to assemble those decoded patches 50 into the training reconstructed image 52.

Formally, the detokenization phase of the VQ configuration may be expressed as:

$$\hat{I} = Dec ( Quant ( {Z}_{1 D} ) ⊕ T ⊕ M )$$

For the KL configuration, the detokenization phase follows a similar formulation but omits the quantizer Quant, since the image decoder 46 operates on continuous representations directly in the KL configuration.

The one or more processing devices 12 are further configured to train the image encoder 36 and the image decoder 46 based at least in part on the training input image 30 and the training reconstructed image 52. The one or more processing devices 12, according to the example of FIG. 1, are configured to compute a value of a loss function 54 based at least in part on the training input image 30 and the training reconstructed image 52. For example, the loss function 54 may include a reconstruction loss term, a perceptual loss term, and an adversarial loss term. The one or more processing devices 12 are further configured to perform gradient descent with respect to the loss function 54 to modify the parameters of the image encoder 36 and the image decoder 46. The one or more processing devices 12 are therefore configured to train the image tokenizer 34 to accurately reconstruct images.

The text-aware 1D image tokenizer 34 discussed above incurs minimal additional computational cost compared to the previous 1D image tokenizer. Despite extending the detokenization sequence length by N, the image tokenizer 34 still requires fewer computations than typical 2D tokenizers, which utilize 256 tokens. In the image tokenizer 34, according to one example, the total number of tokens is instead N+K, where N=77 for the text encoder 22 and where K represents 32, 64, or 128 latent tokens. The configuration of the image tokenizer 34 therefore allows the image tokenizer 34 to retain high efficiency while achieving reconstructions that closely align with text descriptions, effectively mitigating the information loss associated with compact 1D tokenization.

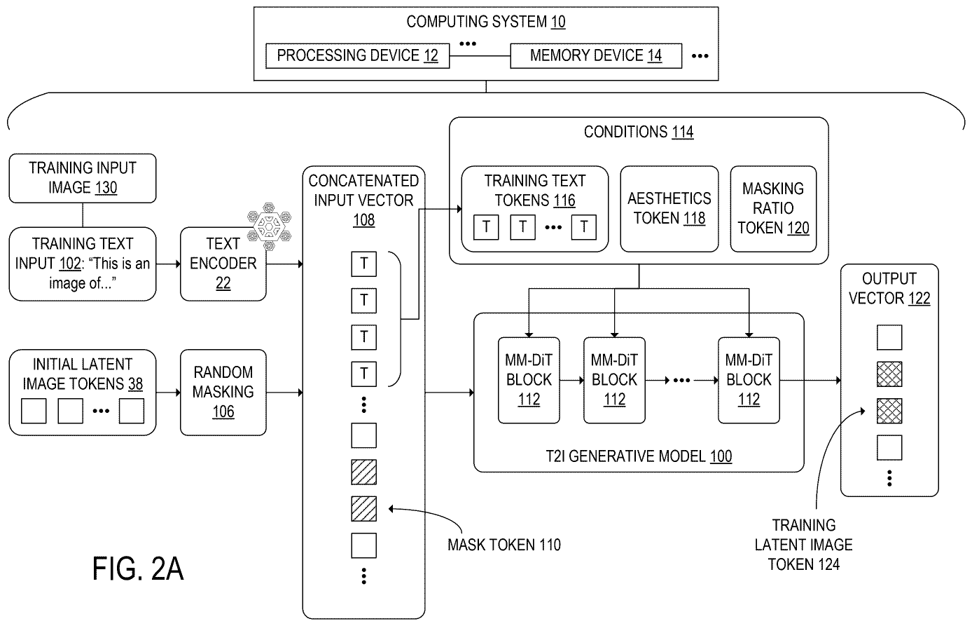

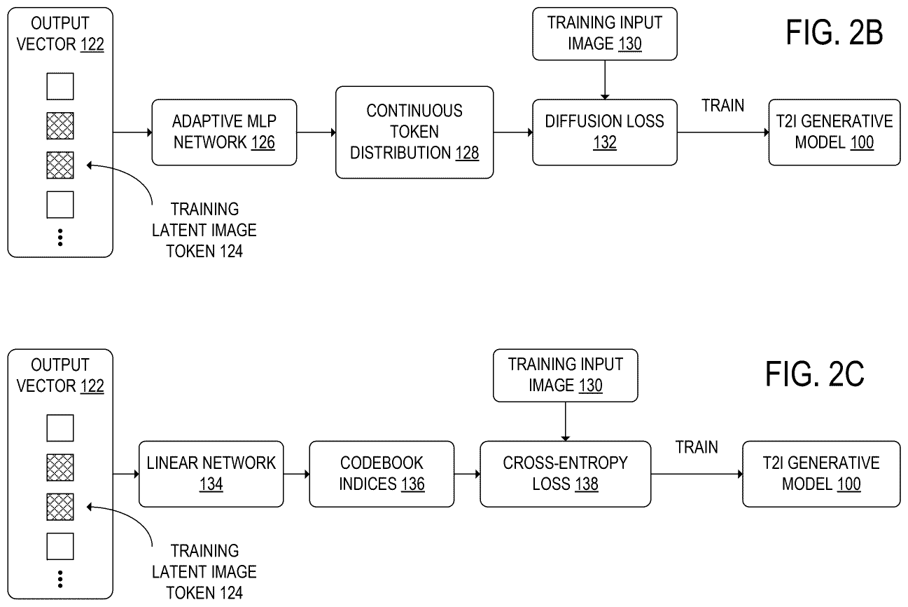

The masked T2I generative model discussed herein leverages the capabilities of the text-aware transformer-based image tokenizer 34. FIGS. 2A-2C schematically shows the computing system 10 during training of the T2I generative model 100. The one or more processing devices 12 are configured to receive a plurality of training input images 130. In addition, the one or more processing devices 12 are further configured to receive a plurality of training text inputs 102 respectively associated with the training input images 130.

FIG. 2A shows the computing system 10 when a training text input 102 of the plurality of training text inputs 102 is processed. For each of the training text inputs 102, the one or more processing devices 12 are further configured to compute one or more training text tokens 116 at the text encoder 22 based at least in part on the training text input 102. The one or more processing devices 12 are configured to utilize the same text encoder 22 in the example of FIG. 2A as in the example of FIG. 1, thereby achieving consistency between the text representations used at the image tokenizer 34 and at the T2I generative model 100. The text encoder 22 is a pretrained text encoder with weights that are frozen during training of the T2I generative model 100.

The one or more processing devices 12 are further configured to compute a concatenated input vector 108 including the one or more training text tokens 116, a plurality of initial latent image tokens 38, and a plurality of mask tokens 110. The initial latent image tokens 38 shown in the example of FIG. 2A are the same latent image tokens 38 that are input into the image encoder 36 in FIG. 1. Computing the concatenated input vector 108 includes applying random masking 106 to a vector of the initial latent image tokens 38 to replace a randomly selected proportion of the initial latent image tokens 38 with mask tokens 110. The specific initial latent image tokens 38 that are replaced during the random masking 106 are also selected randomly.

At the T2I generative model 100, the one or more processing devices 12 are further configured to compute a plurality of training latent image tokens 124 based at least in part on the concatenated input vector 108 over a plurality of sampling stages. The training latent image tokens 124 replace the mask tokens 110 in an output vector 122 that includes the unreplaced initial latent image tokens 38 and the training latent image tokens 124.

The T2I generative model 100 includes a plurality of multimodal diffusion transformer (MM-DiT) blocks 112 in the example of FIG. 2A. A respective sampling stage is performed at each of the MM-DiT blocks 112. Each of the MM-DiT blocks 112 may include separate adaptive (adaLN) layers configured to process text and image modalities, respectively. At the adaLN layers, the one or more processing devices 12 are configured to compute scale and shift parameters based at least in part on sums of pooled text embedding vectors with timestep embedding vectors.

The one or more processing devices 12 are configured to condition the generation of the training latent image tokens 124 at the T2I generative model 100 on a set of conditions 114. The one or more training text tokens 116 are included among the conditions 114. The conditions 114 further include a masking ratio token 120 that specifies the proportion of the training latent image tokens 124 that are covered by mask tokens 110. As the T2I generative model 100 iteratively computes the training latent image tokens 124 that replace the mask tokens 110 over the plurality of sampling stages, the one or more processing devices 12 are configured to update the masking ratio token 120 to match the new proportions of mask tokens 110 in the latent token vector.

In some examples, the conditions 114 further include an aesthetics token 118 that specifies a level of detail in the training latent image tokens 124. The one or more processing devices 12 are further configured to compute the plurality of training latent image tokens 124 with the level of detail specified by the aesthetics token 118.

FIG. 2B schematically shows the further processing of the output vector 122 during training of the T2I generative model 100 in the continuous configuration. In the example of FIG. 2B, the one or more processing devices 12 are further configured to compute a continuous token distribution 128 based at least in part on the training latent image tokens 124 at an adaptive multi-layer perceptron (adaMLP) network 126 included in the T2I generative model 100. While the adaMLP network 126 is included in the T2I generative model 100 during training, the adaMLP network 126 is omitted from the T2I generative model 100 at inference time, as discussed below.

The one or more processing devices 12 are further configured to compute a diffusion loss 132 based at least in part on the continuous token distribution 128. The diffusion loss 132 is computed between the continuous token distribution 128 and the training input image 130 associated with the training text input 102 from which the continuous token distribution 128 is computed. In the example of FIG. 2B, the diffusion loss function includes an additional MLP network 133 at which the one or more processing devices 12 are configured to process the continuous token distribution 128 when computing the diffusion loss 132. The one or more processing devices 12 are further configured to train the T2I generative model 100 based at least in part on the diffusion loss 132. In this example, the one or more processing devices 12 are configured to perform gradient descent over the diffusion loss 132 with respect to the parameters of the T2I generative model 100.

FIG. 2C schematically shows the further processing of the output vector 122 during training of the T2I generative model 100 in the discrete configuration. In the example of FIG. 2C, the one or more processing devices 12 are further configured to compute respective codebook indices 136 of the training latent image tokens 124 at a linear network 134 included in the T2I generative model 100. The one or more processing devices 12 are accordingly configured to map the training latent image tokens 124 onto entries of a learnable codebook in which the indices specify quantized image tokens. The linear network 134 is included in the T2I generative model 100 during training but omitted during inferencing.

The one or more processing devices 12 are further configured to compute a cross-entropy loss 138 based at least in part on the codebook indices 136. The cross-entropy loss 138 is computed between the codebook indices 136 and the training input image 130 associated with the training text input 102 from which the output vector 122 is computed. The one or more processing devices 12 are further configured to train the T2I generative model 100 based at least in part on the cross-entropy loss 138. In this example, the one or more processing devices 12 are configured to perform gradient descent over the cross-entropy loss 138 with respect to the parameters of the T2I generative model 100.

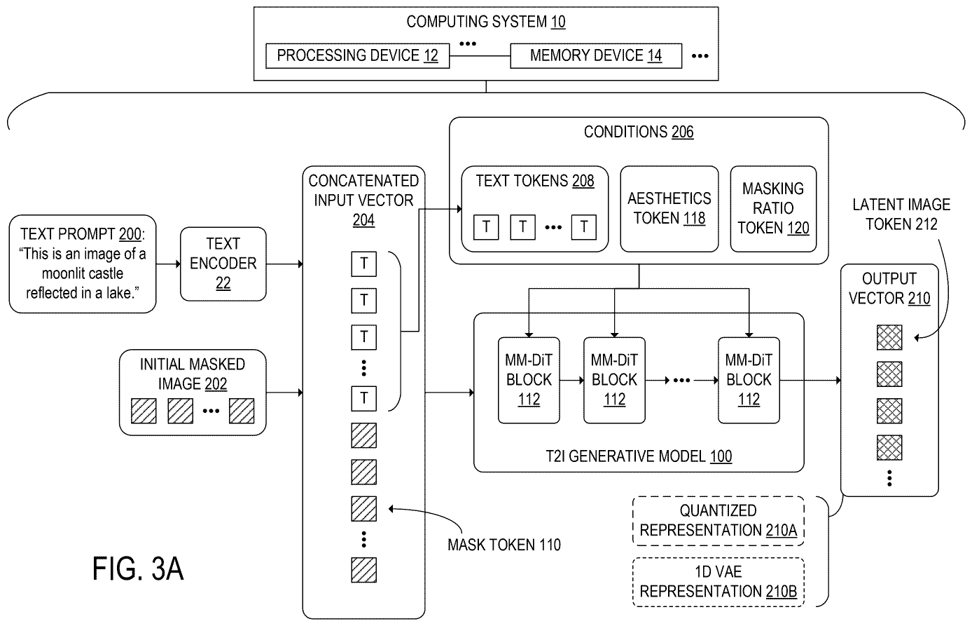

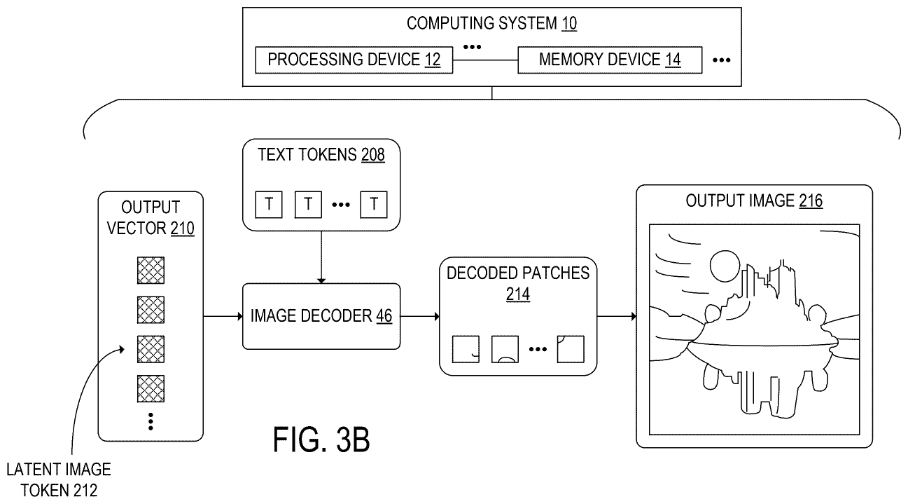

FIGS. 3A-3B schematically show the computing system 10 when the one or more processing devices 12 are configured to execute the T2I generative model 100 at inferencing time. At inferencing time, the one or more processing devices 12 are configured to receive a text prompt 200. The example text prompt in the example of FIGS. 3A-3B is “This is an image of a moonlit castle reflected in a lake.” The one or more processing devices 12 are further configured to compute one or more text tokens 208 at the text encoder 22 based at least in part on the text prompt 200.

The one or more processing devices 12 are further configured to compute an initial masked image 202 including a plurality of mask tokens 110. In some examples, as in FIG. 3A-3B, the plurality of mask tokens 110 fully cover the initial masked image 202. In other examples, such as examples in which image infilling or extension is performed at the T2I generative model 100, the initial masked image 202 may instead include one or more unmasked image tokens.

The one or more processing devices 12 are further configured to compute a concatenated input vector 204 that includes the one or more text tokens 208 and the plurality of mask tokens 110. At the T2I generative model 100, the one or more processing devices 12 are further configured to compute a plurality of latent image tokens 212 based at least in part on the one or more text tokens 208 and the mask tokens 110. The latent image tokens 212 are included in an output vector 210. The one or more processing devices 12 are configured to compute the plurality of latent image tokens 212 at the T2I generative model 100 over a plurality of sampling stages, where a respective sampling stage is performed at each of the MM-DiT blocks 112 included in the T2I generative model 100. The computation of the latent image tokens 212 starts from the initial masked image 202 at an initial sampling stage of the plurality of sampling stages, which is performed at the first MM-DiT block 112.

The one or more processing devices 12 are configured to compute the output vector 210 as a 1D token vector of the plurality of latent image tokens 212. In some examples, as discussed above, the one or more processing devices 12 may be configured to compute the 1D token vector as a quantized representation 210A that maps the latent image tokens 212 to respective codes included in a codebook. Alternatively, the one or more processing devices 12 may be configured to compute the 1D token vector as a 1D variational autoencoder (VAE) representation 210B. Thus, the latent image tokens 212 may be computed in either a continuous configuration or a discrete configuration.

The computation of the latent image tokens 212 at the T2I generative model 100 is further based on a plurality of conditions 206 that include the one or more text tokens 208. In some examples, the one or more processing devices 12 are further configured to receive an aesthetics token 118 at the T2I generative model 100. In such examples, the aesthetics token 118 specifies a level of detail in the output image. The one or more processing devices 12, in such examples, are further configured to compute the plurality of latent image tokens 212 with the level of detail specified by the aesthetics token 118. For example, the user may set the value of the aesthetics token 118 at a user interface as an input to image generation.

The conditions 206 may further include a masking ratio token 120 that specifies a remaining proportion of the mask tokens 110 at a current sampling stage of the plurality of sampling stages. The one or more processing devices 12 are further configured to compute the latent image tokens 212 based at least in part on the masking ratio token 120. As discussed above, the mask tokens 110 are iteratively replaced by latent image tokens 212 when inferencing is performed at the T2I generative model 100. Thus, the masking ratio indicated by the masking ratio token 120 is updated over the course of inferencing. The one or more processing devices 12 may, for example, be configured to project the masking ratio token 120 into sinusoidal embeddings that are concatenated with the pooled text embedding, thereby informing the T2I generative model 100 of the current sampling stage in order to enhance generated image quality.

FIG. 3B schematically shows further processing of the output vector 210 at inferencing time. The one or more processing devices 12 are further configured to process the output vector 210 at the image decoder 46 of the image tokenizer 34. At inferencing time, the image decoder 46 therefore replaces the adaMLP network 126 or the linear network 134 in the processing pipeline of the T2I generative model 100. The image decoder 46 is further configured to receive the one or more text tokens 208 as input. Accordingly, at the image decoder 46, the one or more processing devices 12 are configured to compute an output image 216 based at least in part on the latent image tokens 212 and the one or more text tokens 208. In the example of FIG. 3B, the one or more processing devices 12 are configured to compute a plurality of decoded patches 214 at the image decoder 46, which are then assembled into the output image 216.

The one or more processing devices 12 are further configured to output the output image 216. For example, the output image 216 may be output to a graphical user interface (GUI) for display to a user.

Experimental results for the text-aware transformer-based 1D tokenizer and the masked T2I generative model are provided below.

The experiments use three variants of the text-aware transformer-based 1D tokenizer, each utilizing K=32, 64, or 128 1D latent tokens. Both the image encoder and image decoder utilize a patch size of f=16. For the VQ variant, the codebook is configured with 8192 entries, where each entry is a vector with 64 channels. For the KL variant, the text-aware transformer-based 1D tokenizer uses a continuous embedding with 16 channels.

Two variants of the T2I generative model are introduced: a variant with 568M parameters (referred to as the L variant) and a variant with 1.1B parameters (referred to as the XL variant). For continuous token processing, an additional MLP network (the adaMLP network discussed above) is incorporated into the T2I generative model. The additional MLP network includes eight MLP layers with channel sizes aligned to that of the transformer. This adaMLP network adds 44M parameters and 69M parameters to the L variant and the XL variant, respectively.

Table 1, shown below, summarizes the sizes of different portions of the L and XL variants of the T2I generative model:

| Model | Depth | Width | MLP | Heads | #params |
|---|---|---|---|---|---|
| L | 16 | 1024 | 4096 | 16 | 568M |
| XL | 20 | 1280 | 5120 | 16 | 1.1B |

The MM-DiT blocks are scaled up from the L configuration to the XL configuration.

The training of the text-aware transformer-based 1D tokenizer and the masked T2I generative model utilizes various open-source datasets. All training images are filtered to ensure their longer side is greater than 256 pixels and their aspect ratio is less than 2. The T2I generative model is first pre-trained for image-text alignment. Some portions of the pretraining dataset are filtered to include only images with aesthetic scores higher than 5.0. Following pre-training, the T2I generative model is fine-tuned using images filtered for aesthetic scores above 6.0. In addition, for some portions of the training data, the training images are recaptioned to have more detailed text descriptions.

The text-aware transformer-based 1D tokenizer was trained with a batch size of 1024 for 1 epoch (650 k steps), using a maximum learning rate of 1e-4 and a cosine learning rate schedule. For the T2I generative model with discrete tokens, a batch size of 4096 was employed, leveraging weight tying to stabilize training, with a cosine learning rate schedule and a maximum learning rate of 4e-4. For the T2I generative model with continuous tokens, to accommodate the diffusion loss, a constant learning rate schedule with a maximum rate of 1e-4 and a batch size of 2048 is used. Both variants are trained for 8 epochs, and both variants use the text-aware transformer-based 1D tokenizer extract 128 latent tokens for a 256×256 image. Masked tokens are sampled by randomly selecting the masking rate from [0,1] on a cosine schedule, and text conditioning is randomly dropped with a 0.1 probability to enable classifier-free guidance.

When evaluation is performed, the images are generated from text prompts without rejection sampling, and classifier-free guidance is used to enhance generation quality. The T2I generative model uses 16 and 64 sampling steps for VQ and KL architectures, respectively. To assess different aspects of the models' performance, multiple evaluation metrics are used. For the text-aware transformer-based 1D tokenizer, reconstruction quality is measured using reconstruction FID (rFID) and using inception scores on an ImageNet validation set. For the T2I generative model, a comprehensive set of metrics is utilized: FID on MJHQ to assess aesthetic quality, and GenEval score to measure the alignment between text prompts and their corresponding generated images.

Table 2 summarizes the performance gains achieved by the new one-stage training procedure compared to the original training scheme used for the previous 1D tokenizer:

| | | Training | | | |
|---|---|---|---|---|---|
| Tokenizer | Arch. | Setting | #tokens | rFID ↓ | IS ↑ |
| Previous | VQ | 1-stage | 64 | 5.15 | 120.5 |
| 1D | | | | | |
| Previous | VQ | New 1- | 64 | 2.43 | 179.3 |
| 1D | | stage | | | |

As shown in Table 2, the new one-stage training significantly outperforms the original one-stage training with an rFID improvement of 2.72.

The effects of text-aware detokenization are shown in Table 3. For consistency, all models are trained using the one-stage training approach. The tokenizers are evaluated in a zero-shot setting on the ImageNet validation set, where the caption is represented as “A photo of [class].” Two architectures are compared: discrete tokens (VQ) and continuous tokens (KL). The token count is varied between 32, 64, and 128.

| | | | Previous | | | |
|---|---|---|---|---|---|---|
| | | | 1D | | Text-aware | |
| | Tokens | | tokenizer | | 1D tokenizer | |
| Arch. | # | c | rFID ↓ | IS ↑ | rFID ↓ | IS ↑ |
| VQ | 32 | — | 7.72 | 98.3 | 4.09 (−3.63) | 215.9 (+117.6) |
| | 64 | — | 4.25 | 138.0 | 2.68 (−1.57) | 213.5 (+75.5) |
| | 128 | — | 2.63 | 168.1 | 1.78 (−0.85 | 216.9 (+48.8) |
| KL | 32 | 16 | 2.56 | 171.7 | 1.53 (−1.03) | 222.0 (+50.3) |
| | 64 | 16 | 1.64 | 198.0 | 1.47 (−0.17) | 220.7 (+22.7) |
| | 128 | 16 | 1.02 | 209.7 | 0.90 (−0.12) | 227.7 (+18.0) |

The “c” column indicates the number of channels of continuous tokens. As shown in Table 3, continuous tokens consistently outperform discrete tokens. Additionally, the text-aware 1D tokenizer consistently outperforms the previous 1D tokenizer across all configurations.

Notably, the performance gains shown in Table 3 are most pronounced with a smaller number of tokens (e.g., 32) and with discrete tokens. This increased performance gain at lower token counts occurs as a result of latent tokens primarily capturing low-level image details, while the text embeddings enrich these representations with high-level semantics. Consequently, the increase in performance is more substantial with fewer tokens (where learning semantic details is more challenging) and with vector-quantized tokens (where quantization introduces information loss).

In the text-aware detokenization architecture, either numerical IDs from the text encoder or embeddings from the text encoder may be used. Table 4 show results of ablating this architecture choice:

| | | | Text | | |
|---|---|---|---|---|---|
| Tokenizer | Arch. | #tokens | guidance | rFID ↓ | IS ↑ |
| Text-aware | KL | 32 | ID | 1.62 | 213.6 |
| 1D | | | | | |
| tokenizer | | | | | |
| Text-aware | KL | 32 | Embedding | 1.53 | 222.0 |
| 1D | | | | | |
| tokenizer | | | | | |

This table shows a small improvement in performance from using the embeddings in the de-tokenizer.

The main results of the experiments, including comparisons between the masked T2I generative model and other T2I generative models, are presented below. Table 5 reports the zero-shot T2I generation results on MJHQ-30K:

| | | | | | | Open | | | |
|---|---|---|---|---|---|---|---|---|---|
| Tokenizer | Arch. | Type | Generator | #params | Resolution | data | T ↓ | I ↑ | FID ↓ |
| Previous | VQ | AR | Previous | 775M | 512 × 512 | N | — | — | 25.59 |
| tokenizer 1 | | | T2I model | | | | | | |
| | | | 1 | | | | | | |
| Previous | VQ | Mask | Previous | 1.3B | 256 × 256 | Y | — | 1.0 | 14.99 |
| tokenizer 2 | | | T2I model | | | | | | |
| | | | 2 | | | | | | |
| Text-aware | VQ | Mask. | Masked | 568M | 256 × 256 | Y | 19.8 | 30.9 | 8.75 |
| 1D tokenizer | | | T2I | | | | | | |
| | | | generative | | | | | | |
| | | | model (L) | | | | | | |
| Text-aware | VQ | Diff. | Masked | 1.1B | 256 × 256 | Y | 30.0 | 21.4 | 8.46 |
| 1D tokenizer | | | T2I | | | | | | |
| | | | generative | | | | | | |
| | | | model | | | | | | |
| | | | (XL) | | | | | | |
| VAE | KL | Diff. | Previous | 860M | 768 × 768 | Y | 1041.6 | — | 26.96 |
| | | | T2I model | | | | | | |
| | | | 3 | | | | | | |
| VAE | KL | Diff. | Previous | 630M | 256 × 256 | N | 94.1 | 7.9 | 9.85 |
| | | | T2I model | | | | | | |
| | | | 4 | | | | | | |
| VAE | KL | Diff. | Previous | 2.6B | 1024 × 1024 | N | — | — | 8.76 |
| | | | T2I model | | | | | | |
| | | | 5 | | | | | | |
| Text-aware | KL | Mask. | Masked | 568M + | 256 × 256 | Y | 41.8 | 7.8 | 8.21 |
| | | | T2I | 44M | | | | | |
| 1D tokenizer | | | generative | | | | | | |
| | | | model (L) | | | | | | |
| Text-aware | KL | Mask. | Masked | 1.1B + | 256 × 256 | Y | 50.1 | 7.5 | 7.81 |
| 1D tokenizer | | | T2I | 69M | | | | | |
| | | | generative | | | | | | |
| | | | model | | | | | | |
| | | | (XL) | | | | | | |

This table compares the masked T2I generative model to existing state-of-the-art open-weight models. “VQ” denotes discrete tokenizers and “KL” stands for continuous tokenizers. “Type” indicates the generative model type, where “AR”, “Diff.” and “Mask.” refer to autoregressive models, diffusion models and masked transformer models, respectively. T indicates generator training cost, measured in 8 A100 days using float16 precision. I indicates generator inference throughput, measured in samples per second on a single A100 with batch size 64 using float16 precision. The table compares inference throughput with methods using the same resolution.

As shown above in Table 5, the masked T2I generative model (XL) with discrete tokens achieves a significantly better FID compared to recent autoregressive models such as Previous T2I model 1 (8.46 vs. 25.59) and Previous T2I model 2 (8.46 vs. 14.99), both of which also use VQ tokenizers. Additionally, the masked T2I generative model (XL) offers a 21.4× improvement in inference throughput over Previous T2I model 2, with further gains (30.9× faster) achieved by the lighter masked T2I generative model (L), albeit with a slight performance drop. The masked T2I generative model also demonstrates remarkable resource efficiency. The L variant completes training in just 19.8 8-A100 days, while the XL variant finishes within 30.0 8-A100 days, showcasing both strong performance and efficiency.

In the continuous-token configuration, the masked T2I generative model delivers results competitive with recent diffusion models. The L variant of the masked T2I generative model (568M) outperforms Previous T2I model 4 (630M) (8.97 vs. 9.85), offering similar inference throughput while using fewer parameters and requiring less than half the training resources (41.8 vs. 94.1 8-A100 days). The XL variant (1.1B) further improves the FID score to 8.69, achieving performance on par with Previous T2I model 5, a 2.6B-parameter model trained on high-quality private data, despite the XL variant of the masked T2I generative model being trained exclusively on open data for approximately 50 8-A100 days.

Table 6 summarizes the zero-shot text-to-image generation results on GenEval:

| | | | | Single | Two | | | | Color | Overall |
|---|---|---|---|---|---|---|---|---|---|---|
| Tokenizer | Arch. | Generator | #params | Obj. | Obj. | Counting | Colors | Position | Attri. | ↑ |
| Previous | VQ | Previous | 775M | 0.71 | 0.34 | 0.21 | 0.58 | 0.07 | 0.04 | 0.32 |
| tokenizer 1 | | T2I model 1 | | | | | | | | |
| Previous | VQ | Previous | 1.3B | 0.95 | 0.52 | 0.49 | 0.82 | 0.11 | 0.28 | 0.53 |
| tokenizer 3 | | T2I model 2 | | | | | | | | |
| Text-aware | VQ | Masked T2I | 568M | 0.97 | 0.46 | 0.41 | 0.85 | 0.11 | 0.26 | 0.51 |
| 1D | | generative | | | | | | | | |
| tokenizer | | model (L) | | | | | | | | |
| Text-aware | VQ | Masked T2I | 1.1B | 0.98 | 0.58 | 0.59 | 0.81 | 0.12 | 0.26 | 0.56 |
| 1D | | generative | | | | | | | | |
| tokenizer | | model (XL) | | | | | | | | |
| VAE | KL | Previous | 860M | 0.97 | 0.38 | 0.35 | 0.76 | 0.04 | 0.06 | 0.43 |
| | | T2I model 6 | | | | | | | | |
| VAE | KL | Previous | 630M | 0.96 | 0.49 | 0.47 | 0.79 | 0.06 | 0.11 | 0.48 |
| | | T2I model 4 | | | | | | | | |
| VAE | KL | Previous | 860M | 0.98 | 0.51 | 0.44 | 0.85 | 0.07 | 0.17 | 0.50 |
| | | T2I model 3 | | | | | | | | |
| VAE | KL | Previous | 2.6B | 0.98 | 0.74 | 0.39 | 0.85 | 0.15 | 0.23 | 0.55 |
| | | T2I model 5 | | | | | | | | |
| Text-aware | KL | Masked T2I | 568M + | 0.93 | 0.52 | 0.29 | 0.78 | 0.09 | 0.19 | 0.49 |
| 1D | | generative | 44M | | | | | | | |
| tokenizer | | model (L) | | | | | | | | |
| Text-aware | KL | Masked T2I | 1.1B + | 0.95 | 0.54 | 0.35 | 0.84 | 0.13 | 0.24 | 0.53 |
| 1D | | generative | 69M | | | | | | | |
| tokenizer | | model (XL) | | | | | | | | |

Using discrete tokens, the L variant of the masked T2I generative model (568M) achieves an overall score of 0.51, significantly outperforming the recent autoregressive model Previous T2I model 1 by 0.19 and performing on par with the larger Previous T2I model 2. Moreover, the larger XL variant achieves the highest overall score on the benchmark, with a score of 0.56. This result notably surpasses Previous T2I model 5, a 2.6B-parameter model (2.36× larger than the XL variant of the masked T2I generative model) trained on proprietary data. In addition, the masked T2I generative model with continuous tokens also achieves an overall score of 0.53, comparable to recent diffusion models but with much lower training costs and with training exclusively on open data.

As shown in Tables 5 and 6, the KL variants of the masked T2I generative model consistently outperform the VQ variants on MJHQ-30K in terms of FID but perform slightly worse on GenEval's overall score. The KL variants excel in generating diverse, highly aesthetic images, contributing to improved FID on MJHQ-30K. However, they fall behind on GenEval, which emphasizes object-focused compositional properties such as object co-occurrence, position, count, and color. In contrast, the VQ variants, which are constrained by a finite codebook, generate less diverse but more compositionally accurate images, leading to higher scores on GenEval.

Additional implementation details for the text-aware transformer-based 1D tokenizer and the masked T2I generative model are provided below.

Table 7 provides the complete list of hyper-parameters used for training the masked T2I generative model with both discrete and continuous tokenizers:

| Hyperparameter | Discrete | Continuous |
|---|---|---|
| Optimizer | AdamW | AdamW |
| β₁ | 0.9 | 0.9 |
| β₂ | 0.96 | 0.95 |
| Weight decay | 0.03 | 0.02 |
| LR (pre-training) | 0.0004 | 0.0002 |
| LR (fine-tuning) | 0.0001 | 0.0002 |
| LR scheduling | cosine | constant |
| LR warmup steps | 10K | 50K |
| Batch size | 4096 | 2048 |
| Training steps (pre- | 500K | 1000K |
| training) | | |
| Training steps (fine- | 250K | 500K |
| tuning) | | |

The VQ variants of the masked T2I generative model have shorter training times, primarily due to a larger batch size and fewer training iterations, as shown in Table 7. During inference, the VQ models are also significantly faster, owing to the differences in the diffusion process used in KL variants, which, in turn, enable the KL variants to generate more diverse and aesthetic images.

For efficient ablation experiments, the pre-trained version of the masked T2I generative model is used rather than the final fine-tuned version, allowing assessment of architectural choices without additional training overhead. Using the L variant with a discrete tokenizer, performance is assessed using the FID score, computed on a 5K image subset from the COCO2017 validation split.

Table 8 presents an ablation study on the number of tokens used for text-to-image generation:

| Arch. | Generator | #tokens | T ↓ | I ↑ | FID-5K ↓ |
|---|---|---|---|---|---|
| VQ | Masked T2I | 32 | 9.7 | 51.2 | 28.49 |
| | generative | | | | |
| | model (L) | | | | |
| | | 64 | 10.8 | 41.0 | 26.60 |
| | | 128 | 13.2 | 30.9 | 24.48 |

As shown in the above table, the masked T2I generative model achieves higher generation quality with more tokens but incurs longer training times and slower inference speeds.

Another experiment shows the effects of incorporating additional conditioning signals. As shown in Table 9, using both aesthetic scores and masking ratios enhances generation quality:

| Arch. | Generator | Aesthetic | Masking | FID-5K ↓ |
|---|---|---|---|---|
| VQ | Masked T2I | | | 25.11 |
| | generative | | | |
| | model (L) | | | |
| | | | Y | 24.96 |
| | | Y | | 24.70 |
| | | Y | Y | 24.48 |

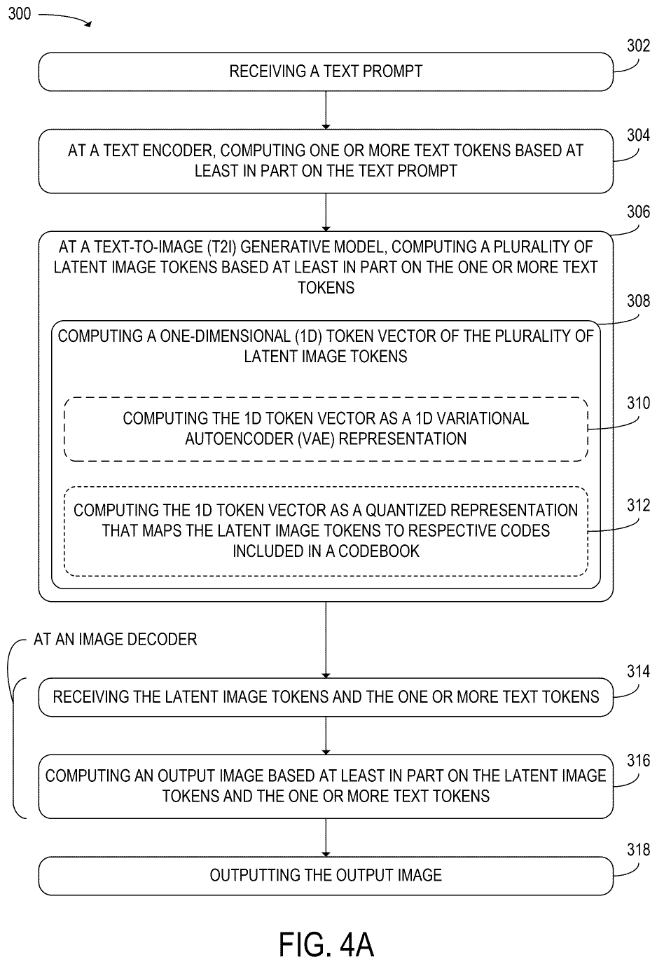

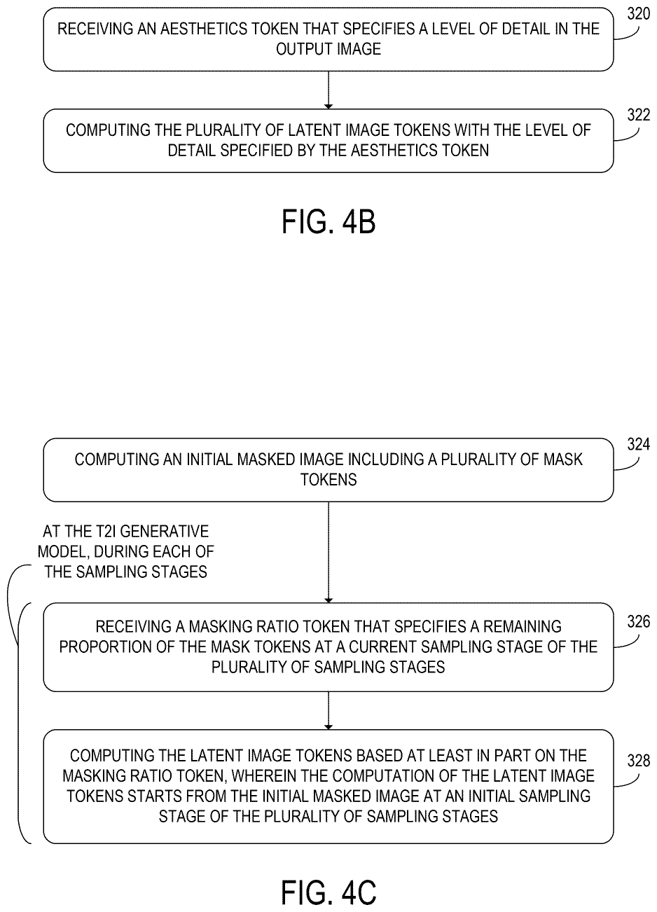

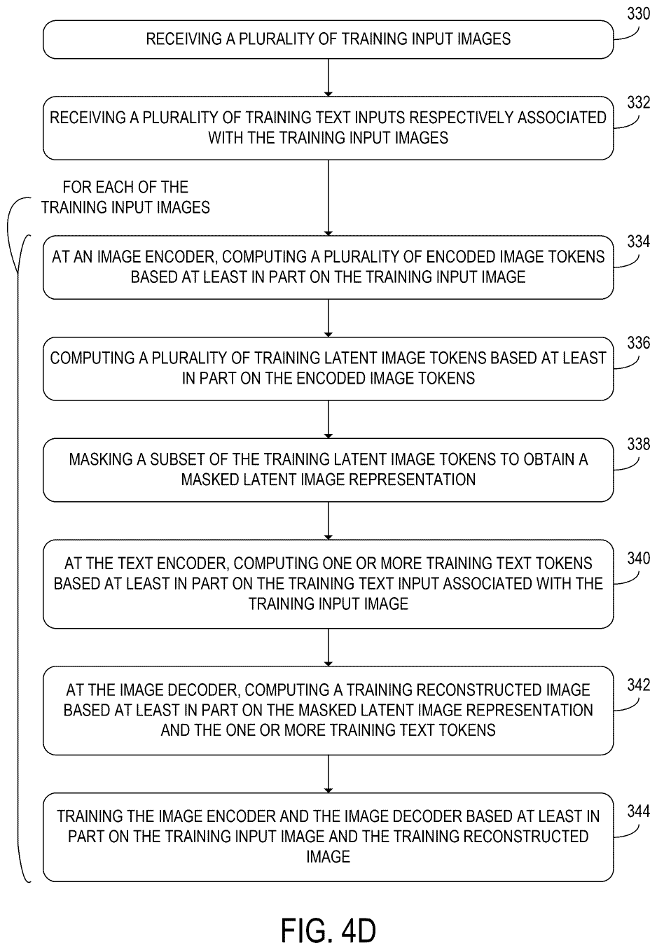

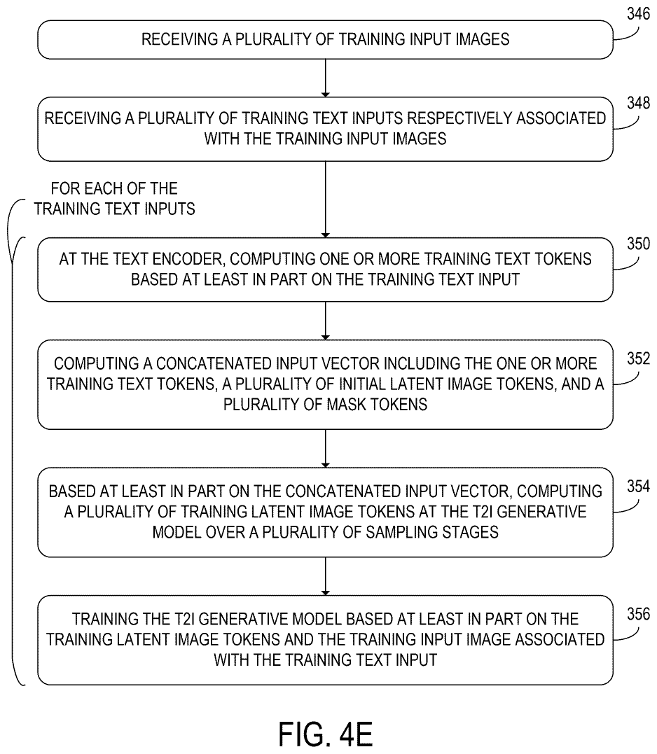

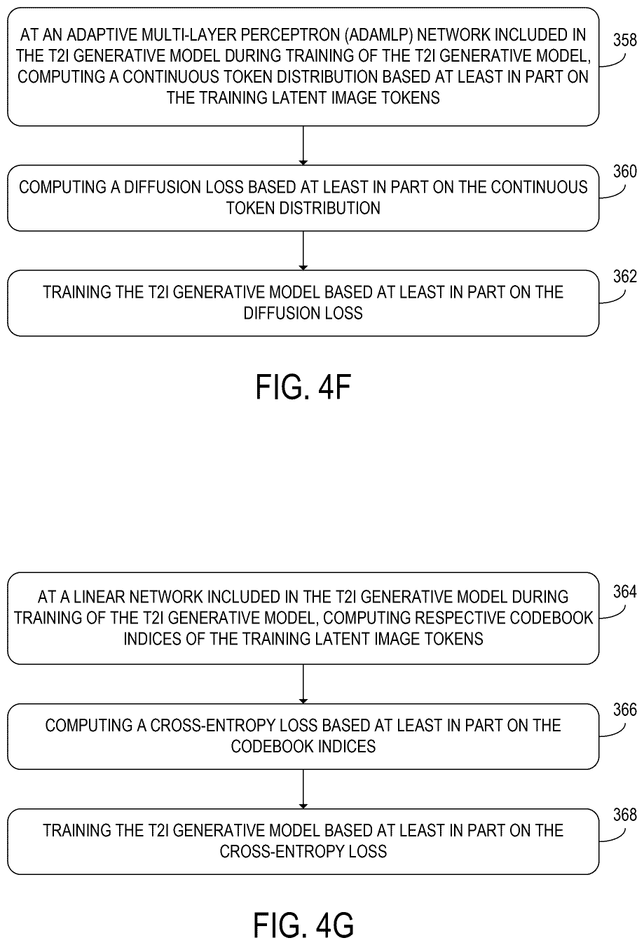

FIG. 4A shows a flowchart of a method 300 for use with a computing system to perform T2I image generation. At step 302, the method 300 includes receiving a text prompt. For example, the text prompt may be received via a user interface. At step 304, the method 300 further includes computing one or more text tokens at a text encoder based at least in part on the text prompt.

At step 306, the method 300 further includes computing a plurality of latent image tokens at a T2I generative model. These latent image tokens are computed based at least in part on the one or more text tokens. At step 308, step 306 may include computing a one-dimensional (1D) token vector of the plurality of latent image tokens. In some examples, at step 310, step 308 may include computing the 1D token vector as a 1D variational autoencoder (VAE) representation. Accordingly, the image decoder has a continuous token configuration in such examples. Alternatively, at step 312, step 308 may include computing the 1D token vector as a quantized representation that maps the latent image tokens to respective codes included in a codebook. The image decoder has a discrete token configuration in such examples.

Steps 314 and 316 of the method 300 are performed at an image decoder. At step 314, the method 300 further includes receiving the latent image tokens and the one or more text tokens. At step 316, the method 300 further includes computing an output image based at least in part on the latent image tokens and the one or more text tokens. The image decoder may compute a plurality of decoded patches that are assembled into the output image. By using the text tokens as well as the latent image tokens as input, the image decoder may compute an output image that more accurately reflects the contents of the text prompt.

At step 318, the method 300 further includes outputting the output image. The output image may be output to a GUI for display to the user.

FIGS. 4B-4G show additional steps of the method 300 that are performed in some examples. FIG. 4B shows steps that may be performed at the T2I generative model in some examples. At step 320, the method 300 may further include receiving an aesthetics token that specifies a level of detail in the output image. For example, the aesthetics token may be received as a user-specified parameter. At step 322, the method 300 may further include computing the plurality of latent image tokens with the level of detail specified by the aesthetics token. The aesthetics token thereby provides the user with additional control over the properties of the output image.

FIG. 4C shows additional steps of the method 300 that may be performed in some examples. At step 324, the method 300 may further include computing an initial masked image including a plurality of mask tokens. The mask tokens may fully cover the initial masked image. Alternatively, when the T2I generative model is used to perform image extension or infilling, the mask tokens may instead cover a proper subset of the initial masked image.

Steps 326 and 328 may be performed at the T2I generative model during each of a plurality of sampling stages. The sampling stages may be performed at respective transformer blocks included in the T2I generative model. At step 326, the method 300 may further include receiving a masking ratio token that specifies a remaining proportion of the mask tokens at a current sampling stage of the plurality of sampling stages. The masking ratio token may be updated at each sampling stage.

At step 328, the method 300 may further include computing the latent image tokens based at least in part on the masking ratio token. The computation of the latent image tokens starts from the initial masked image at an initial sampling stage of the plurality of sampling stages. Thus, the masking ratio token may increase the quality of the output image by conditioning the generation of the latent image tokens on the proportion of mask tokens that have been replaced by latent image tokens.

FIG. 4D shows additional steps that may be performed to train the image decoder. The image decoder is included in an image tokenizer that also includes an image encoder. At step 330, the method 300 may further include receiving a plurality of training input images. In addition, at step 332, the method 300 may further include receiving a plurality of training text inputs respectively associated with the training input images.

Steps 334, 336, 338, 340, 342, and 344 may be performed for each of the training input images. At step 334, the method 300 may further include, at an image encoder, computing a plurality of encoded image tokens based at least in part on the training input image. The image encoder may, for example, be structured as a vision transformer.

At step 336, the method 300 may further include computing a plurality of training latent image tokens based at least in part on the encoded image tokens. The training latent image tokens may be computed at least in part at a VQ quantizer in examples in which the image tokenizer is a discrete tokenizer. Alternatively, the training latent image tokens may be computed at a KL regularizer in examples in which the image tokenizer is a continuous tokenizer.

At step 338, the method 300 may further include masking a subset of the training latent image tokens to obtain a masked latent image representation. For example, a randomly selected proportion of the training latent image tokens may be masked, and within that proportion, the training latent image tokens that are replaced with mask tokens may be randomly selected.

At step 340, the method 300 may further include computing one or more training text tokens at the text encoder based at least in part on the training text input associated with the training input image. The same pretrained text encoder may be used in steps 304 and 340. During training of the image tokenizer, the weights of the text encoder may be kept frozen.

At step 342, the method 300 may further include computing a training reconstructed image at the image decoder based at least in part on the masked latent image representation and the one or more training text tokens. The image decoder may also be a vision transformer. The image decoder may compute the training reconstructed image as a vector of decoded patches.

At step 344, the method 300 may further include training the image encoder and the image decoder based at least in part on the training input image and the training reconstructed image. The training input image may be used as a ground-truth image that is compared to the training reconstructed image using a loss function. The values of the loss function computed for the different text-image pairs may then be used to perform gradient descent to train the image encoder and the image decoder. By incorporating the training text tokens in the decoding process, the image decoder may reconstruct more accurate approximations of the training images.

FIG. 4E shows additional steps of the method 300 that may be performed to train the T2I generative model. At step 346, the method 300 may further include receiving a plurality of training input images. In addition, at step 348, the method 300 may further include receiving a plurality of training text inputs respectively associated with the training input images.

Steps 350, 352, 354, and 356 may be performed for each of the training text inputs. At step 350, the method 300 may further include, at the text encoder, computing one or more training text tokens based at least in part on the training text input. The same pretrained text encoder may be used in steps 304 and 350. During training of the T2I generative model, the weights of the text encoder may be kept frozen.

At step 352, the method 300 may further include computing a concatenated input vector including the one or more training text tokens, a plurality of initial latent image tokens, and a plurality of mask tokens. Random masking may be applied to the initial latent image tokens to cover a randomly selected proportion of the initial latent image tokens with mask tokens. Within that randomly selected proportion, the specific initial latent image tokens that are masked may also be randomly selected.

At step 354, the method 300 may further include computing a plurality of training latent image tokens at the T2I generative model based at least in part on the concatenated input vector. The training latent image tokens may be computed over a plurality of sampling stages that correspond to transformer blocks included in the T2I generative model.

At step 356, the method 300 may further include training the T2I generative model based at least in part on the training latent image tokens and the training input image associated with the training text input. The training input images may accordingly be used as ground-truth images during training of the T2I generative model.

FIG. 4F shows additional steps of the method 300 that may be performed when training the T2I generative model according to the steps of FIG. 4E in examples in which the T2I generative model utilizes a continuous token distribution. At step 358, the method 300 may further include computing the continuous token distribution based at least in part on the training latent image tokens. The continuous token distribution may be computed at an adaptive multi-layer perceptron (adaMLP) network included in the T2I generative model during training of the T2I generative model. This adaMLP network may be replaced with the image decoder during inferencing.

At step 360, the method 300 may further include computing a diffusion loss based at least in part on the continuous token distribution. The diffusion loss may also be computed based at least in part on the training input image, such that the training input image acts as a ground-truth image. At step 362, the method 300 may further include training the T2I generative model based at least in part on the diffusion loss.

FIG. 4G shows additional steps of the method 300 that may be performed when training the T2I generative model according to the steps of FIG. 4E in examples in which the T2I generative model utilizes a discrete token distribution. At step 364, the method 300 may further include computing respective codebook indices of the training latent image tokens at a linear network included in the T2I generative model during training of the T2I generative model. The codebook indices are one-hot indices in a learnable codebook of discrete tokens. The linear network may be replaced with the image decoder during inferencing.

At step 366, the method 300 may further include computing a cross-entropy loss based at least in part on the codebook indices. The cross-entropy loss may also be computed based at least in part on the training input image, such that the training input image acts as a ground-truth image. At step 368, the method 300 may further include training the T2I generative model based at least in part on the cross-entropy loss.

The above discussion introduces a text-aware transformer-based 1D tokenizer that increases semantic alignment between text prompts and image outputs in T2I generation. This 1D tokenizer achieves higher reconstruction quality while also having a lower training time than previous image tokenizers. In addition, the above discussion introduces a masked T2I generative model that supports both discrete and continuous tokens. Through compact 1D tokenization, the masked T2I generative model reduces training costs and accelerates sampling, making efficient, high-quality generation more accessible. The masked T2I generative model leverages publicly available data and an efficient tokenizer design to advance masked generative model performance.

The methods and processes described herein are tied to a computing system of one or more computing devices. In particular, such methods and processes can be implemented as a computer-application program or service, an application-programming interface (API), a library, and/or other computer-program product.

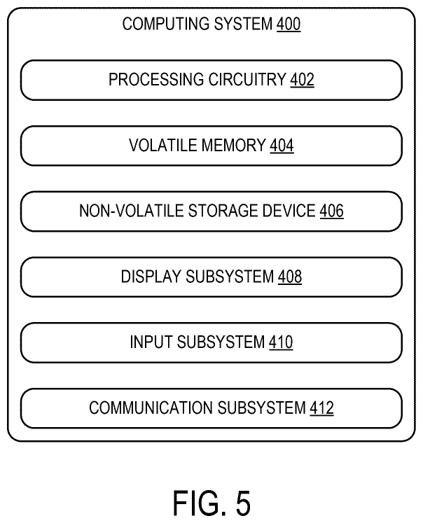

FIG. 5 schematically shows a non-limiting embodiment of a computing system 400 that can enact one or more of the methods and processes described above. Computing system 400 is shown in simplified form and may instantiate the computing system 10 depicted in FIG. 1. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 5.

Processing circuitry 402 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions.

Processors of the processing circuitry 402 may be single-core or multi-core, and the instructions executed thereon may be configured for sequential, parallel, and/or distributed processing. Individual components of the processing circuitry 402 optionally may be distributed among two or more separate devices, which may be remotely located and/or configured for coordinated processing. For example, aspects of the computing system 400 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 402.

Non-volatile storage device 406 includes one or more physical devices configured to hold instructions executable by the processing circuitry 402 to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. Non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. Volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device 406, and thus transform the state of the non-volatile storage device 406, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, camera, or microphone.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 400 to send and/or receive messages to and/or from other devices via a network such as the Internet.

The following paragraphs provide additional description of the subject matter of the present disclosure. According to one aspect of the present disclosure, a computing system is provided, including one or more processing devices configured to receive a text prompt. At a text encoder, the one or more processing devices are further configured to compute one or more text tokens based at least in part on the text prompt. At a text-to-image (T2I) generative model, the one or more processing devices are further configured to compute a plurality of latent image tokens based at least in part on the one or more text tokens. At an image decoder, the one or more processing devices are further configured to receive the latent image tokens and the one or more text tokens. At the image decoder, the one or more processing devices are further configured to compute an output image based at least in part on the latent image tokens and the one or more text tokens. The one or more processing devices are further configured to output the output image. The above features may have the technical effect of increasing semantic alignment between the text prompt and the output image by conditioning the image decoding on the text tokens.

According to this aspect, the one or more processing devices may be configured to compute a one-dimensional (1D) token vector of the plurality of latent image tokens. The above feature may have the technical effect of allowing each latent image token to potentially represent any region of the output image rather than being specific to a single image patch. This region-independence may increase sampling speed.

According to this aspect, the one or more processing devices may be configured to compute the 1D token vector as a 1D variational autoencoder (VAE) representation. The above feature may have the technical effect of allowing the image decoder to perform continuous decoding on the 1D token vector.

According to this aspect, the one or more processing devices may be configured to compute the 1D token vector as a quantized representation that maps the latent image tokens to respective codes included in a codebook. The above feature may have the technical effect of allowing the image decoder to perform discrete decoding on the 1D token vector.

According to this aspect, the one or more processing devices may be further configured to compute an initial masked image including a plurality of mask tokens. At the T2I generative model, during each of a plurality of sampling stages the one or more processing devices may be further configured to receive a masking ratio token that specifies a remaining proportion of the mask tokens at a current sampling stage of the plurality of sampling stages. At the T2I generative model, during each of the sampling stages the one or more processing devices may be further configured to compute the latent image tokens based at least in part on the masking ratio token. The computation of the latent image tokens may start from the initial masked image at an initial sampling stage of the plurality of sampling stages. The above features may have the technical effect of informing the T2I generative model of the current sampling stage in order to enhance generated image quality.

According to this aspect, at the T2I generative model, the one or more processing devices may be further configured to receive an aesthetics token that specifies a level of detail in the output image. The one or more processing devices may be further configured to compute the plurality of latent image tokens with the level of detail specified by the aesthetics token. The above features may have the technical effect of allowing the user to control the level of detail with which the output image is generated.

According to this aspect, the one or more processing devices may be further configured to receive a plurality of training input images. The one or more processing devices may be further configured to receive a plurality of training text inputs respectively associated with the training input images. For each of the training input images, at an image encoder, the one or more processing devices may be further configured to compute a plurality of encoded image tokens based at least in part on the training input image. The one or more processing devices may be further configured to compute a plurality of training latent image tokens based at least in part on the encoded image tokens. The one or more processing devices may be further configured to mask a subset of the training latent image tokens to obtain a masked encoded image representation. At the text encoder, the one or more processing devices may be further configured to compute one or more training text tokens based at least in part on the training text input associated with the training input image. At the image decoder, the one or more processing devices may be further configured to compute a training reconstructed image based at least in part on the masked encoded image representation and the one or more training text tokens. The one or more processing devices may be further configured to train the image encoder and the image decoder based at least in part on the training input image and the training reconstructed image. The above features may have the technical effect of training the image decoder to incorporate text tokens when decoding latent image tokens.

According to this aspect, the one or more processing devices may be further configured to receive a plurality of training input images. The one or more processing devices may be further configured to receive a plurality of training text inputs respectively associated with the training input images. For each of the training text inputs, at the text encoder, the one or more processing devices may be further configured to compute one or more training text tokens based at least in part on the training text input. For each of the training text inputs, the one or more processing devices may be further configured to compute a concatenated input vector including the one or more training text tokens, a plurality of initial latent image tokens, and a plurality of mask tokens. For each of the training text inputs, based at least in part on the concatenated input vector, the one or more processing devices may be further configured to compute a plurality of training latent image tokens at the T2I generative model over a plurality of sampling stages. For each of the training text inputs, the one or more processing devices may be further configured to train the T2I generative model based at least in part on the training latent image tokens and the training input image associated with the training text input. The above features may have the technical effect of training the T2I generative model to perform masked T2I generation.

According to this aspect, the one or more processing devices may be further configured to compute a continuous token distribution based at least in part on the training latent image tokens at an adaptive multi-layer perceptron (adaMLP) network included in the T2I generative model during training of the T2I generative model. The one or more processing devices may be further configured to compute a diffusion loss based at least in part on the continuous token distribution. The one or more processing devices may be further configured to train the T2I generative model based at least in part on the diffusion loss. The above features may have the technical effect of training the T2I generative model to generate images from continuous token distributions.

According to this aspect, the one or more processing devices may be further configured to compute respective codebook indices of the training latent image tokens at a linear network included in the T2I generative model during training of the T2I generative model. The one or more processing devices may be further configured to compute a cross-entropy loss based at least in part on the codebook indices. The one or more processing devices may be further configured to train the T2I generative model based at least in part on the cross-entropy loss. The above features may have the technical effect of training the T2I generative model to generate images from discrete token distributions.

According to another aspect of the present disclosure, a method for use with a computing system is provided. The method includes receiving a text prompt. The method further includes at a text encoder, computing one or more text tokens based at least in part on the text prompt. At a text-to-image (T2I) generative model, the method further includes computing a plurality of latent image tokens based at least in part on the one or more text tokens. At an image decoder, the method further includes receiving the latent image tokens and the one or more text tokens. The method further includes computing an output image based at least in part on the latent image tokens and the one or more text tokens. The method further includes outputting the output image. The above features may have the technical effect of increasing semantic alignment between the text prompt and the output image by conditioning the image decoding on the text tokens.

According to this aspect, the method may further include comprising computing a one-dimensional (1D) token vector of the plurality of latent image tokens. The above feature may have the technical effect of allowing each latent image token to potentially represent any region of the output image rather than being specific to a single image patch. This region-independence may increase sampling speed.

According to this aspect, the 1D token vector may be computed as a 1D variational autoencoder (VAE) representation. The above feature may have the technical effect of allowing the image decoder to perform continuous decoding on the 1D token vector.

According to this aspect, the 1D token vector may be computed as a quantized representation that maps the latent image tokens to respective codes included in a codebook. The above feature may have the technical effect of allowing the image decoder to perform discrete decoding on the 1D token vector.

According to this aspect, the method may further include, at the T2I generative model, receiving an aesthetics token that specifies a level of detail in the output image. The method may further include, at the T2I generative model, computing the plurality of latent image tokens with the level of detail specified by the aesthetics token. The above features may have the technical effect of allowing the user to control the level of detail with which the output image is generated.

According to this aspect, the method may further include receiving a plurality of training input images. The method may further include receiving a plurality of training text inputs respectively associated with the training input images. For each of the training input images, at an image encoder, the method may further include computing a plurality of encoded image tokens based at least in part on the training input image. For each of the training input images, the method may further include computing a plurality of training latent image tokens based at least in part on the encoded image tokens. For each of the training input images, the method may further include masking a subset of the training latent image tokens to obtain a masked latent image representation. For each of the training input images, at the text encoder, the method may further include computing one or more training text tokens based at least in part on the training text input associated with the training input image. For each of the training input images, at the image decoder, the method may further include computing a training reconstructed image based at least in part on the masked latent image representation and the one or more training text tokens. For each of the training input images, the method may further include training the image encoder and the image decoder based at least in part on the training input image and the training reconstructed image. The above features may have the technical effect of training the image decoder to incorporate text tokens when decoding latent image tokens.

According to this aspect, the method may further include receiving a plurality of training input images. The method may further include receiving a plurality of training text inputs respectively associated with the training input images. For each of the training text inputs, at the text encoder, the method may further include computing one or more training text tokens based at least in part on the training text input. For each of the training text inputs, the method may further include computing a concatenated input vector including the one or more training text tokens, a plurality of initial latent image tokens, and a plurality of mask tokens. For each of the training text inputs, based at least in part on the concatenated input vector, the method may further include computing a plurality of training latent image tokens at the T2I generative model over a plurality of sampling stages. For each of the training text inputs, the method may further include training the T2I generative model based at least in part on the training latent image tokens and the training input image associated with the training text input. The above features may have the technical effect of training the T2I generative model to perform masked T2I generation.

According to this aspect, at an adaptive multi-layer perceptron (adaMLP) network included in the T2I generative model during training of the T2I generative model, the method may further include computing a continuous token distribution based at least in part on the training latent image tokens. The method may further include computing a diffusion loss based at least in part on the continuous token distribution. The method may further include training the T2I generative model based at least in part on the diffusion loss. The above features may have the technical effect of training the T2I generative model to generate images from continuous token distributions.

According to this aspect, at a linear network included in the T2I generative model during training of the T2I generative model, the method may further include computing respective codebook indices of the training latent image tokens. The method may further include computing a cross-entropy loss based at least in part on the codebook indices. The method may further include training the T2I generative model based at least in part on the cross-entropy loss. The above features may have the technical effect of training the T2I generative model to generate images from discrete token distributions.

According to another aspect of the present disclosure, a computing system is provided, including one or more processing devices configured to, in a training stage, receive a plurality of training input images and receive a plurality of training text inputs respectively associated with the training input images. For each of the training input images, the one or more processing devices are further configured to, at an image encoder, compute a plurality of encoded image tokens based at least in part on the training input image. The one or more processing devices are further configured to compute a plurality of training latent image tokens based at least in part on the encoded image tokens. The one or more processing devices are further configured to mask a subset of the plurality of training latent image tokens to obtain a masked latent image representation. The one or more processing devices are further configured to, at the text encoder, compute one or more training text tokens based at least in part on the training text input associated with the training input image. The one or more processing devices are further configured to, at the image decoder, compute a training reconstructed image based at least in part on the masked latent image representation and the one or more training text tokens. The one or more processing devices are further configured to train the image encoder and the image decoder based at least in part on the training input image and the training reconstructed image. In an inferencing stage, at the image decoder, the one or more processing devices are further configured to receive a plurality of latent image tokens and one or more text tokens. The one or more processing devices are further configured to compute an output image based at least in part on the latent image tokens and the one or more text tokens. The one or more processing devices are further configured to output the output image. The above features may have the technical effect of training an image decoder and using the image decoder during the inferencing stage to decode the output image in a manner that is conditioned on the text tokens. This text token conditioning at the decoder may increase the semantic alignment between a text prompt and the output image.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a text prompt;
at a text encoder, compute one or more text tokens based at least in part on the text prompt;
at a text-to-image (T2I) generative model, compute a plurality of latent image tokens based at least in part on the one or more text tokens;
at an image decoder:
receive the latent image tokens and the one or more text tokens; and
compute an output image based at least in part on the latent image tokens and the one or more text tokens; and
output the output image.

2. The computing system of claim 1, wherein the one or more processing devices are configured to compute a one-dimensional (1D) token vector of the plurality of latent image tokens.

3. The computing system of claim 2, wherein the one or more processing devices are configured to compute the 1D token vector as a 1D variational autoencoder (VAE) representation.

4. The computing system of claim 2, wherein the one or more processing devices are configured to compute the 1D token vector as a quantized representation that maps the latent image tokens to respective codes included in a codebook.

5. The computing system of claim 1, wherein the one or more processing devices are further configured to:
compute an initial masked image including a plurality of mask tokens;
at the T2I generative model, during each of a plurality of sampling stages:
receive a masking ratio token that specifies a remaining proportion of the mask tokens at a current sampling stage of the plurality of sampling stages; and
compute the latent image tokens based at least in part on the masking ratio token, wherein the computation of the latent image tokens starts from the initial masked image at an initial sampling stage of the plurality of sampling stages.

6. The computing system of claim 1, wherein, at the T2I generative model, the one or more processing devices are further configured to:
receive an aesthetics token that specifies a level of detail in the output image; and
compute the plurality of latent image tokens with the level of detail specified by the aesthetics token.

7. The computing system of claim 1, wherein the one or more processing devices are further configured to:
receive a plurality of training input images;
receive a plurality of training text inputs respectively associated with the training input images; and
for each of the training input images:
at an image encoder, compute a plurality of encoded image tokens based at least in part on the training input image;
compute a plurality of training latent image tokens based at least in part on the encoded image tokens;
mask a subset of the training latent image tokens to obtain a masked encoded image representation;
at the text encoder, compute one or more training text tokens based at least in part on the training text input associated with the training input image;
at the image decoder, compute a training reconstructed image based at least in part on the masked encoded image representation and the one or more training text tokens; and
train the image encoder and the image decoder based at least in part on the training input image and the training reconstructed image.

8. The computing system of claim 1, wherein the one or more processing devices are further configured to:
receive a plurality of training input images;
receive a plurality of training text inputs respectively associated with the training input images; and
for each of the training text inputs:
at the text encoder, compute one or more training text tokens based at least in part on the training text input;
compute a concatenated input vector including the one or more training text tokens, a plurality of initial latent image tokens, and a plurality of mask tokens;
based at least in part on the concatenated input vector, compute a plurality of training latent image tokens at the T2I generative model over a plurality of sampling stages; and
train the T2I generative model based at least in part on the training latent image tokens and the training input image associated with the training text input.

9. The computing system of claim 8, wherein the one or more processing devices are further configured to:
at an adaptive multi-layer perceptron (adaMLP) network included in the T2I generative model during training of the T2I generative model, compute a continuous token distribution based at least in part on the training latent image tokens;
compute a diffusion loss based at least in part on the continuous token distribution; and
train the T2I generative model based at least in part on the diffusion loss.

10. The computing system of claim 8, wherein the one or more processing devices are further configured to:
at a linear network included in the T2I generative model during training of the T2I generative model, compute respective codebook indices of the training latent image tokens;
compute a cross-entropy loss based at least in part on the codebook indices; and
train the T2I generative model based at least in part on the cross-entropy loss.

11. A method for use with a computing system, the method comprising:
receiving a text prompt;
at a text encoder, computing one or more text tokens based at least in part on the text prompt;
at a text-to-image (T2I) generative model, computing a plurality of latent image tokens based at least in part on the one or more text tokens;
at an image decoder:
receiving the latent image tokens and the one or more text tokens; and
computing an output image based at least in part on the latent image tokens and the one or more text tokens; and
outputting the output image.

12. The method of claim 11, further comprising computing a one-dimensional (1D) token vector of the plurality of latent image tokens.

13. The method of claim 12, wherein the 1D token vector is computed as a 1D variational autoencoder (VAE) representation.

14. The method of claim 12, wherein the 1D token vector is computed as a quantized representation that maps the latent image tokens to respective codes included in a codebook.

15. The method of claim 11, further comprising, at the T2I generative model:
receiving an aesthetics token that specifies a level of detail in the output image; and
computing the plurality of latent image tokens with the level of detail specified by the aesthetics token.

16. The method of claim 11, further comprising:
receiving a plurality of training input images;
receiving a plurality of training text inputs respectively associated with the training input images; and
for each of the training input images:
at an image encoder, computing a plurality of encoded image tokens based at least in part on the training input image;
computing a plurality of training latent image tokens based at least in part on the encoded image tokens;
masking a subset of the training latent image tokens to obtain a masked latent image representation;
at the text encoder, computing one or more training text tokens based at least in part on the training text input associated with the training input image;
at the image decoder, computing a training reconstructed image based at least in part on the masked latent image representation and the one or more training text tokens; and
training the image encoder and the image decoder based at least in part on the training input image and the training reconstructed image.

17. The method of claim 11, further comprising:
receiving a plurality of training input images;
receiving a plurality of training text inputs respectively associated with the training input images; and
for each of the training text inputs:
at the text encoder, computing one or more training text tokens based at least in part on the training text input;
computing a concatenated input vector including the one or more training text tokens, a plurality of initial latent image tokens, and a plurality of mask tokens;
based at least in part on the concatenated input vector, computing a plurality of training latent image tokens at the T2I generative model over a plurality of sampling stages; and
training the T2I generative model based at least in part on the training latent image tokens and the training input image associated with the training text input.

18. The method of claim 17, further comprising:
at an adaptive multi-layer perceptron (adaMLP) network included in the T2I generative model during training of the T2I generative model, computing a continuous token distribution based at least in part on the training latent image tokens;
computing a diffusion loss based at least in part on the continuous token distribution; and
training the T2I generative model based at least in part on the diffusion loss.

19. The method of claim 17, further comprising:
at a linear network included in the T2I generative model during training of the T2I generative model, computing respective codebook indices of the training latent image tokens;
computing a cross-entropy loss based at least in part on the codebook indices; and
training the T2I generative model based at least in part on the cross-entropy loss.

20. A computing system comprising:
one or more processing devices configured to:
in a training stage:
receive a plurality of training input images;
receive a plurality of training text inputs respectively associated with the training input images;
for each of the training input images:
at an image encoder, compute a plurality of encoded image tokens based at least in part on the training input image;
compute a plurality of training latent image tokens based at least in part on the encoded image tokens;
mask a subset of the plurality of training latent image tokens to obtain a masked latent image representation;
at the text encoder, compute one or more training text tokens based at least in part on the training text input associated with the training input image;
at the image decoder, compute a training reconstructed image based at least in part on the masked latent image representation and the one or more training text tokens; and
train the image encoder and the image decoder based at least in part on the training input image and the training reconstructed image; and
in an inferencing stage, at the image decoder:
receive a plurality of latent image tokens and one or more text tokens;
compute an output image based at least in part on the latent image tokens and the one or more text tokens; and
output the output image.
